(19) United States
(12) Patent Application Publication
(10) Pub. No.: US 2020/0051377 A1
(43) Pub. Date: Feb. 13, 2020

(54) AWARD GENERATION IN A LINKED POOL OF GAMING MACHINES

(71) Applicant: Atlas Gaming Technologies Pty Ltd., Port Melbourne (AU)

(72) Inventors: Daniel Julio Montenegro, Port Melbourne (AU); Robert Sloot, Port Melbourne (AU); Alessandro Ciampoli, Port Melbourne (AU); Zenja Solaja, Port Melbourne (AU); Boris Mitelman, Port Melbourne (AU)

(73) Assignee: Atlas Gaming Technologies Pty Ltd., Port Melbourne (AU)

(21) Appl. No.: 16/538,220

(22) Filed: Aug. 12, 2019

(30) Foreign Application Priority Data
Aug. 13, 2018 (AU) 2018902964

(51) Int. Cl. G07F 17/32

(52) U.S. Cl. CPC G07F 17/3225; G07F 17/3267; G07F 17/3258

(57) ABSTRACT

Some embodiments relate to a gaming host machine configured to communicate with a pool of gaming machines. The gaming machine capable of receiving a message from a first gaming machine, the first gaming machine being part of the pool of gaming machines, the message indicating occurrence of a first winning event on the first gaming machine. The gaming machine determining a first set of eligible gaming machines from the pool of gaming machines and then sending a first bonus game trigger message to each of the first set of eligible gaming machines. The first bonus game trigger message comprising instructions to trigger a first bonus game on each of the first set of eligible gaming machines resulting in the gaming machine receiving a first bonus game outcome message from each of the eligible gaming machines.

### CROSS-REFERENCE TO RELATED APPLICATION

The present application claims priority from Australian Patent Application No. 2018902964, filed Aug. 13, 2018, the disclosure of which is hereby incorporated herein by reference.

### TECHNICAL FIELD

Described embodiments generally relate to methods and systems for facilitating communication among a pool of gaming machines. In particular, described embodiments relate to facilitating communication to allow for shared award generation among a linked pool of gaming machines.

### BACKGROUND

Some gaming machines offer linked gaming methods and systems, where the input credit from several linked machines is pooled into a single facility that can be won by any one of the linked machines. A participating gaming machine may be awarded the entire pooled credit. Other participating gaming machines may be awarded nominal fixed credits when the entire pooled credit is awarded. It is desired to address or ameliorate one or more shortcomings or disadvantages associated with prior systems and methods for linked gaming, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a gaming host machine configured to communicate with a pool of gaming machines, the gaming host machine comprising: a processor; memory storing executable program code; wherein the processor is configured to execute the program code to: receive a message from a first gaming machine, the first gaming machine being part of the pool of gaming machines, the message indicating occurrence of a first winning event on the first gaming machine; determine a first set of eligible gaming machines from the pool of gaming machines; send a first bonus game trigger message to each of the first set of eligible gaming machines, the first bonus game trigger message comprising instructions to trigger a first bonus game on each of the first set of eligible gaming machines; and receive a first bonus game outcome message from each of the eligible gaming machines.

Some embodiments relate to a gaming host machine wherein the processor is further configured to determine occurrence of a second winning event on a second gaming machine based on the received first bonus game outcome messages, the second gaming machine being one of the first set of eligible gaming machines.

Some embodiments relate to a gaming host machine wherein in response to determining occurrence of the second winning event, the processor is further configured to determine a second set of eligible gaming machines from the pool of gaming machines; send a second bonus game trigger message to each of the second set of eligible gaming machines, the second bonus game trigger message comprising instructions to trigger a second bonus game on each of the second set of eligible gaming machines; receive a second bonus game outcome message from each of the second set of eligible gaming machines.

Some embodiments relate to a gaming host machine wherein the processor is further configured to determine occurrence of a third winning event on a third gaming machine based on one or more of the received second bonus game outcome messages.

Some embodiments relate to a gaming host machine wherein the processor is further configured to receive activity level messages from each gaming machine part of the pool of gaming machines, the activity level messages indicating gaming activity level on each gaming machine.

Some embodiments relate to a gaming host machine wherein the determination of the first set of eligible gaming machines is based on the gaming activity level on each of the pool of gaming machines.

Some embodiments relate to a gaming host machine wherein the determination of the second set of eligible gaming machines is based on the gaming activity level on each gaming machine in the pool of gaming machines.

Some embodiments relate to a gaming system comprising the gaming host machine and at least one gaming machine, the gaming comprising: a gaming machine processor; gaming machine memory storing executable program code; at least one display to display game-related images; and input components to receive player input; wherein the processor is configured to execute the program code to: transmit a message to the gaming host machine, the message indicating occurrence of a first winning event on the gaming machine; receive a first bonus game trigger message from the gaming host machine, the first bonus game trigger message comprising instructions to trigger a first bonus game; trigger the first bonus game, determine an outcome of the first bonus game; transmit a first bonus game outcome message to the gaming host machine; wherein the at least one gaming machine is part of the pool of gaming machines.

Some embodiments relate to a gaming system wherein the gaming machine processor is further configured to execute the program code to: receive a second bonus game trigger message, the second bonus game trigger message comprising instructions to trigger a second bonus game; trigger a second bonus game, determine an outcome of the second bonus game; transmit a second bonus game outcome message to the gaming host machine.

Some embodiments relate to a gaming system, wherein the gaming machine processor is further configured to execute the program code to transmit activity level messages to the gaming host system, the activity level messages indicating gaming activity level on the at least one gaming machine.

Some embodiments relate to a gaming system wherein the gaming machine processor is further configured to determine activity level based on wager denominations on the at least one gaming machine over a period of time.

Some embodiments relate to a method of gaming comprising the steps of: receiving, by a gaming host machine a message from a first gaming machine, the first gaming machine being part of the pool of gaming machines, the message indicating occurrence of a first winning event on the first gaming machine; determining, by the gaming host machine a first set of eligible gaming machines from the pool of gaming machines; sending, by the gaming host machine a first bonus game trigger message to each of the first set of eligible gaming machines, the first bonus game trigger message comprising instructions to trigger a first bonus game on each of the first set of eligible gaming machines; receiving, by the gaming host machine, a first bonus game outcome message from each of the eligible gaming machines.

Some embodiments relate to a method of gaming further comprising the step of determining, by the gaming host machine, occurrence of a second winning event on a second gaming machine based on the received first bonus game outcome messages, the second gaming machine being one of the first set of eligible gaming machines.

Some embodiments relate to a method of gaming, further comprising, in response to determining occurrence of the second winning event, the steps of: determining, by the gaming host machine, a second set of eligible gaming machines from the pool of gaming machines; sending, by the gaming host machine, a second bonus game trigger message to each of the second set of eligible gaming machines, the second bonus game trigger message comprising instructions to trigger a second bonus game on each of the second set of eligible gaming machines; receiving, by the gaming host machine, a second bonus game outcome message from each of the second set of eligible gaming machines.

Some embodiments relate to a method of gaming further comprising, determining, by the gaming host machine, occurrence of a third winning event on a third gaming machine based on one or more of the received second bonus game outcome messages.

Some embodiments relate to a method of gaming further comprising the step of, receiving, by the gaming host machine, activity level messages from each gaming machine part of the pool of gaming machines, the activity level messages indicating gaming activity level on each gaming machine.

Some embodiments relate to a method of gaming wherein the determination of the first set of eligible gaming machines is based on the gaming activity level on each of the pool of gaming machines.

Some embodiments relate to a method of gaming wherein the determination of the second set of eligible gaming machines is based on the gaming activity level on each gaming machine in the pool of gaming machines.

Some embodiments relate to a method of gaming further comprising the steps of: transmitting, by at least one gaming machine a message to the gaming host machine, the message indicating occurrence of a first winning event on the gaming machine; receiving, by the gaming machine, a first bonus game trigger message from the gaming host machine, the first bonus game trigger message comprising instructions to trigger a first bonus game; triggering, on the gaming machine, the first bonus game, determining, by the gaming machine, an outcome of the first bonus game; transmitting, by the gaming machine, a first bonus game outcome message to the gaming host machine; wherein the at least one gaming machine is part of the pool of gaming machines.

Some embodiments relate to a method of gaming further comprising the steps of: receiving, by the at least one gaming machine, a second bonus game trigger message, the second bonus game trigger message comprising instructions to trigger a second bonus game; triggering, on the at least one gaming machine, a second bonus game, determining, by the at least one gaming machine, an outcome of the second bonus game; transmitting, by the at least one gaming machine, a second bonus game outcome message to the gaming host machine.

Some embodiments relate to a method of gaming further comprising the step of transmitting, by the at least one gaming machine, activity level messages to the gaming host system, the activity level messages indicating gaming activity level on the at least one gaming machine.

Some embodiments relate to a method of gaming wherein the activity level is based on wager denominations on the at least one gaming machine over a period of time.

Some embodiments relate to a gaming machine configured to communicate with a linked progressive controller machine, the gaming machine comprising:
at least one gaming machine processor;
gaming machine memory storing executable program code;
at least one display to display game-related images; and
input components to receive player input;
wherein the at least one gaming machine processor is configured to execute the program code to:
receive a progressive meter value message from the linked progressive controller machine, the progressive meter value message indicating a change in the progressive meter value;
on determining a decrement or reset of a progressive meter value based on the progressive meter value message, trigger a first bonus game;
determine an outcome of the first bonus game;
wherein the at least one gaming machine is part of a pool of gaming machines and the linked progressive controller machine transmits the progressive meter value message to at least another gaming machine part of the pool of gaming machines.

Some embodiments relate to a gaming system comprising one or more gaming machines, and a linked progressive controller machine configured to communicate with each of the one or more gaming machines, wherein the linked progressive controller machine comprises:
at least one linked progressive machine processor;
linked progressive machine memory storing executable program code;

wherein the at least one linked progressive machine processor is configured to execute the program code to transmit a progressive meter value message to the one or more gaming machines, the progressive meter value message indicating a change in the progressive meter value.

### BRIEF DESCRIPTION OF DRAWINGS

Embodiments are described in further detail below, by way of example and with reference to the accompanying drawings, in which:

FIG. 1 is a diagrammatic representation of a gaming machine in accordance with some embodiments;

FIG. 2 is a block diagram of some components of the gaming machine of FIG. 1;

FIG. 3 is a block diagram of a gaming system;

FIG. 4 is a diagrammatic representation of stages of a linked bonus game being executed by the gaming system of FIG. 3;

FIG. 5 is a flowchart showing steps for execution of a linked bonus game on the gaming host server of FIG. 3;

FIG. 6 is a flowchart showing steps for execution of a linked bonus game on the gaming machine of FIG. 1;

FIGS. 7, 8 and 9 are screenshots displaying various stages of a first game on the gaming machine of FIG. 1;

FIGS. 10, 11, 12, 13, 14 and 15 are screenshots displaying various stages of a bonus game on the gaming machine of FIG. 1;

FIG. 16 is a block diagram of a gaming system with a linked progressive controller; and

FIG. 17 is a flowchart showing steps for execution of a linked bonus game on the gaming machine of FIG. 1 as part of the gaming system of FIG. 16.

### DESCRIPTION OF EMBODIMENTS

Described embodiments generally relate to methods and systems for award generation in a linked pool of gaming machines. In particular, embodiments relate to gaming host machines that are configured to communicate with a pool of gaming machines to facilitate linked or associated gaming events and awards.

Community slot machines are slot machines that are part of a system of machines that are linked together to contribute to single jackpot pool. Often, the jackpot amount will be displayed on a bigger screen that is viewable by all the players. Like any slot machine, community slot machines may offer bonuses and payouts. The present application relates to a system of gaming machines having a common bonus round feature. At pre-set or randomly determined intervals, a bonus round will launch. Some or all of the players playing at the linked machines may be given the opportunity to participate in these bonus rounds.

Described embodiments offer variable reoccurring consolation prizes to participating gaming machines on a network link, as part of a bonus game feature. If one of the interconnected gaming machines wins a reoccurring prize, all eligible gaming machines may be eligible to be awarded another reoccurring prize. This process can go on multiple times in a cascading or ricochet-like effect.

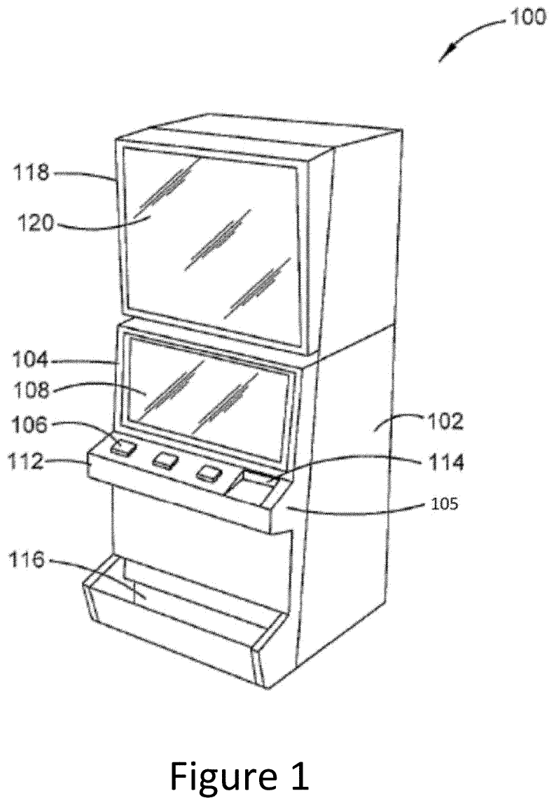

In FIG. 1, reference numeral 100 generally designates a stand-alone gaming system including a game. A stand-along gaming system may be a system which can operate by itself based on inputs received from a player and which requires no further interaction from other systems. Hereinafter, the stand-alone gaming system 100 will be referred to as a gaming machine 100.

The gaming machine 100 includes a console 102 which contains all or most components required to implement a game play whereby a player wins or loses a wager. Access to the interior components is by way of a hinged door 105. Moulded or otherwise affixed to the exterior of the console 102 is a display means in the form of at least one visual display unit 104 on which one or more games is played. The video display unit 104 may be implemented as a liquid crystal display, a plasma screen, as a cathode ray screen device or the like. According to some embodiments, visual display unit 104 may comprise a touch screen display. What is displayed on the visual display unit 104 will depend on what the intended goal of the unit is in relation to the player and any other potential participants in the gaming system.

According to some embodiments, gaming machine 100 may comprise more than one display means. For example, in the illustrated embodiment, gaming machine 100 includes a top box 118 on which secondary screen 120 is carried in the form of an electronic visual display unit. According to some embodiments, instead of a secondary screen 120, top box 118 may comprise other display means, which could include displays made from physical materials such as paper, plastic banners or posters. The secondary screen 120 or other display means may display generic information related to the machine or gaming system, or secondary screen 120 may display information specifically relating to a particular game to be played on the machine 100. Whilst the secondary screen 120 is shown as being carried on the top box 118, secondary screen 120 can also be positioned in or on the bottom panel of the door 105, or any other part of the gaming machine 100 visible to the player.

According to some embodiments, one or more of visual display unit 104 and secondary screen 120 may be configured to display 1920×1080 pixels resolution at a 60 Hz refresh rate. According to some embodiments, one or more of visual display unit 104 and secondary screen 120 may be flat. In some embodiments, one or more of visual display unit 104 and secondary screen 120 may be curved. One or more of visual display unit 104 and secondary screen 120 may be concavely curved along the horizontal axis so that the side edges of the screen curve toward a position in front of the gaming machine 100 where the player would normally be.

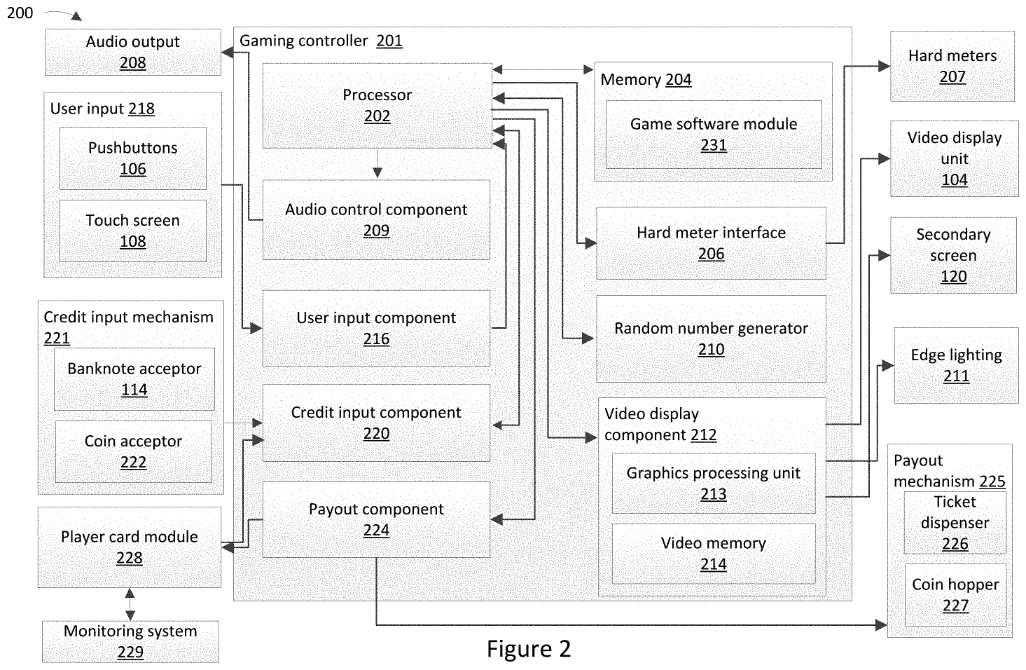

In some embodiments, one or more of visual display unit 104 and secondary screen 120 may comprise edge lighting 211 (shown in FIG. 2). Edge lighting 211 may be LED lighting located around the edge of visual display unit 104 and/or secondary screen 120, and may be configured to switch on and off and/or change colour during gameplay.

The gaming machine 100 includes a tactile user input 218 (shown in FIG. 2) configured to allow a player to interact via touch with the gaming machine 100. In this example, the tactile input is in the form of a combination of pushbuttons 106 and a touch screen 108 for enabling a player to play one or more games. The touch screen 108 comprises an electronic visual display that can detect the presence and location of a touch within the display area. According to some embodiments, touch screen 108 may be integrated into at least one of video display unit 104 and secondary display unit 120. The touch screen 108 may be used in between the end of a game and the start of a next game, for example for the player/user to access game information and/or do a limited amount of configuration, such as adjust screen brightness, volume or other functional aspects not affecting a game outcome.

The touch screen 108 may be used during the game play between the start of a game and the end of a game. According to some embodiments, a game is considered to have started once a wager is placed and considered complete once the wager has been lost or won. Pushbuttons 106 may include one or more buttons which are physically actuatable by a user. Functions of pushbuttons 106 may include: initiation of game play, credit output, gameplay selection, completion of gameplay etc. A midtrim 112 of the machine 100 houses the pushbuttons 106.

It should be appreciated that tactile user input 218 may include any suitable device that enables the player to produce an input signal that is received by the processor. Tactile input in the form of pushbuttons 106 and/or regions on touch screen 108 may include a one bet button, a max bet button, or a repeat-the-bet button. With a one bet button, for instance, the player places a bet by pushing the one bet button. The player may increase the bet by one credit each time the player pushes the one bet button.

The midtrim 112 also houses a credit input mechanism 221 (shown in FIG. 2), including a banknote acceptor 114, configured to accept banknotes and provide a player with a corresponding amount of credit. According to some embodiments, banknote acceptor 114 may also be configured to operate as a ticket-in-ticket-out device, accepting tickets representative of a credit amount. Such tickets may be printed by other machines located in a gaming venue. Banknote acceptor 114 may be configured to communicate with credit input component 220 via a specific protocol over a serial link, which may be a RS232 link, or similar. The credit input mechanism 221 may further include a coin acceptor 222 (shown in FIG. 2), configured to accept coins and provide a player with a corresponding amount of credit. According to some embodiments, gaming machine 100 may optionally include a player card module 228 (shown in FIG. 2), which may act as a credit input mechanism in some embodiments, player card module 228 may comprise, a card and/or ticket reader, a magnetic reading head for reading a magnetic stripe card, an electronic reader for a proximity card, a near field communications reader or any other form of electronic, wireless or contact that can input credit to the gaming machine. According to some embodiments, player card module 228 may replace credit input mechanism 221 in a gaming machine 100.

A payout mechanism 225 is mounted beneath the console 102 and is provided for cash payouts from the machine 100 to the player. According to some embodiments, payout mechanism 225 comprises a coin hopper 227 which dispenses coins or tokens equal to the amount of credit currently on the machine, into a coin tray 116. Aside from the coin hopper 227 and coin tray 116, the payout mechanism 225 may also include one or more of: a ticket dispenser 226 for issuing a ticket dispensed by a printer which the user can redeem for cash; a note dispenser; a near field communications transmitter; or other means to enable wireless or remote credit transfer. A ticket dispensed by ticket dispenser 226 may be able to be redeemed by a player at a cashier station at the gaming venue. According to some embodiments, ticket dispenser 226 may be configured to communicate with payout component 224 via a serial or USB interface. It should be appreciated that any suitable payout mechanisms, such as funding to the player's electronically recordable identification card or smart card, may be implemented in accordance with the gaming machine 100 disclosed herein. According to some embodiments, player card module 228 may act as a payout mechanism. According to some embodiments, player card module 228 may replace credit input mechanism 221 in a gaming machine 100.

The gaming machine 100 further includes audio output 208 (shown in FIG. 2) to provide auditory feedback to the player of the gaming machine 100. According to some embodiments, audio output 208 may comprise one or more speakers, subwoofers, earphones, or other audio output mechanisms. In some embodiments, audio output 208 may provide a stereo audio output. According to some embodiments, audio output 208 may comprise two speakers and a subwoofer.

During game play on gaming machine 100, a player may: read game play instructions via video display unit 104 and/or secondary screen 120; insert credit into gaming machine 100 via credit input mechanism 221; initiate a game or series of games by interacting with user input 218 via pushbuttons 106 and/or touch screen 108; and observe the outcome of the game via video display unit 104, secondary screen 120 and/or audio output 208. A player may be able to collect any remaining or accumulated credit at any time via payout mechanism 225.

Referring to FIG. 2 of the drawings, game logic circuitry and componentry 200 is illustrated. The game logic circuitry and componentry 200 includes a gaming controller 201. The gaming controller 201 may be disposed in a logic cage, for example. The logic cage includes a box-like mechanical cage structure that has slots to guide logic cards into the proper location for electronically plugging into a backplane mounted at the rear of the cage structure. The backplane has connectors for accepting mating connectors on the logic cards. The logic cage and associated cards serve to at least partly define the functional capabilities of the game controller 201 and form one of the basic components of the gaming machine 100. The logic cage is securely housed within the cabinet of the gaming machine 100. Circuitry and componentry 200 may be configured to combine features of an industrial computer, such as ruggedness and reliability, with high processing power and 3D rendering capability sufficient to display entertaining games.

Central to the logic cage is at least one processor 202 which may act as a central processing unit and may include a processor, a microcontroller-based platform, a suitable integrated circuit, or one or more application-specific integrated circuits (ASICs). Processor 202 may include more than one processing chip or component, but the singular term processor 202 is used herein for convenience. Processor 202 may be configured to be powerful enough to be able to perform floating point calculations for a physics engine, and 3D rendering calculations to allow for the display of 3D animations. According to some embodiments, processor 202 may comprise at least a dual core CPU capable of running at at least 1.6 GHz. The processor 202 is in communication with or operable to access or to exchange signals with memory 204. Memory 204 may comprise RAM, ROM, a non-volatile memory in the form of a compact flash, battery backed up memory, or other memory devices. RAM may include DRAM, non-volatile RAM (NVRAM), magnetic RAM (MRAM), ferroelectric RAM (FeRAM), and other forms as commonly understood in the gaming industry.

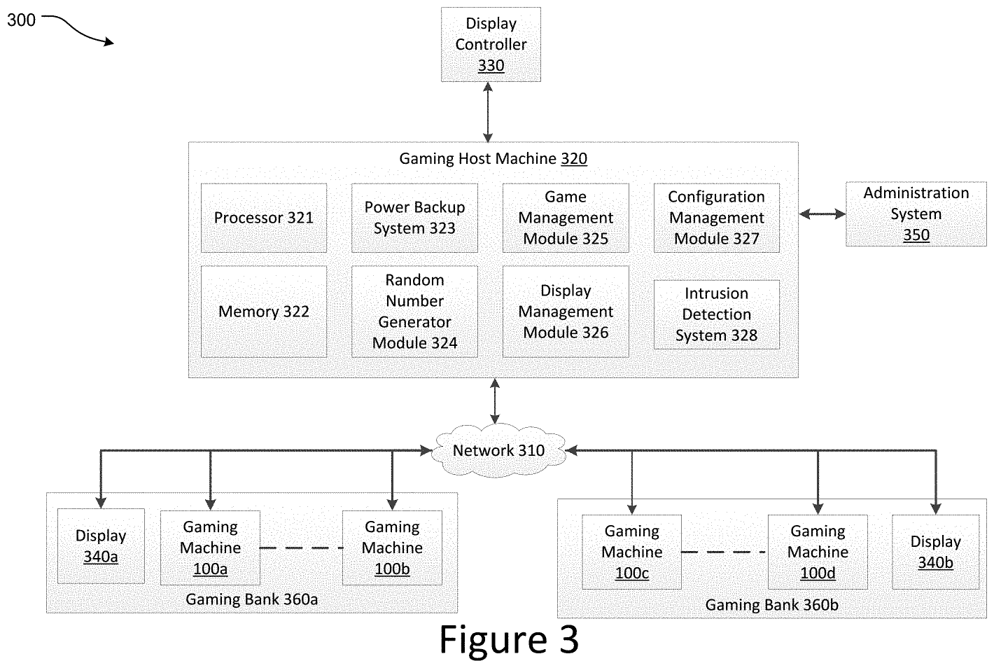

Memory 204 stores game software module 231. Game software module 231 comprises one or more executable code modules accessible by processor 202. Game software module 231 may store game pay logic rules and credit processing rules, that govern when and how much credit a player should receive based on the outcome of a game, as well as processing credit input by the player. Game software module 231 may also store game graphics code and resources that allow processor 202 to cause graphics to be generated and displayed via video display component 212, and audio processing instructions that allow processor 202 to instruct audio control component 209 to generate audio data. Game software module 231 may further store input/output processing software to allow processor 202 to facilitate communications between gaming controller 201 and user inputs 218, as well as outputs 208, 104, 120 and 211. According to some embodiments, game software module 231 may also store communications software that allows gaming machine 100 to communicate with external devices, as described in further detail below with reference to FIG. 3. According to some embodiments, memory 204 may comprise at least 4 GB of DRAM, to allow for game software module 231 to be stored on DRAM.

According to some embodiments, gaming machine 100 may comprise safety intrusion monitoring and security. This may comprise one or more sensors on the body and inside gaming machine 100, to detect unauthorised tampering with gaming machine 100 Gaming machine 100 may also comprise power failure handling and recovery features, which may include back-up battery systems and battery-backed up recovery memory devices that preserve data should a power down period occur where gaming machine 100 loses power. According to some embodiments, gaming machine 100 may comprise at least 2 MB of battery backed up storage Gaming machine 100 may also comprise a logging microprocessor operating on battery power to perform intrusion monitoring functions during a power down period.

Processor 202 may also be in communication with audio output 208 via an audio control module 209. The audio control module 209 has its own digital signal processor, analogue to digital converters, amplifiers and other circuitry necessary to broadcast the output from the speakers.

The processor 202 runs executable code residing in game software module 231 of memory 204 that facilitates play of the game by a player through the display devices 104 and 120, and/or pushbuttons 106 and touchscreen 108 mounted in display devices 104 and 120. Processor 202 may communicate with user input 218 via user input component 216, and with video display unit 104, secondary screen 102 and edge lighting 211 via video display component 212. Video display component 212 may comprise a graphics processing unit (GPU) 213 to allow graphics to be generated, as well as video memory 214 configured to store data for display. GPU 213 may comprise a 3D programing application programming interface (API), which may be an OpenGL, Vulcan, or DirectX API, for example. GPU 213 is preferably powerful enough to allow for graphics to be generated on-the-fly and displayed on video display unit 104 and/or secondary screen 120. Where video display unit 104 and secondary screen 120 have a resolution of 1920×1080 each, for example, GPU 213 may be configured to be powerful enough to perform real-time rendering of a resolution of 1920×2160 (combined) at a refresh rate of 60 Hz. According to some embodiments, the speed of rendering performed by GPU 213 may be at least 100 frames per second. According to some embodiments, GPU 213 may be configured to support BC7 compression.

Data used by GPU 213 may be stored in video memory 214, which may comprise a form of DRAM, such as video random access memory (VRAM). VRAM may be used as VRAM may be faster than DRAM, although in some embodiments DRAM may also be used as VRAM. According to some embodiments, video memory 214 may comprise at least 1 GB of VRAM.

The processor 202 may receive input signals from user input 218 and drive the screen of video display unit 104 and/or secondary screen 120

Processor 202 may also receive input signal pulses from credit input component 220 and payout component 224 to determine whether or not a player has provided sufficient credit from either payment device 114 or 222 to commence playing, and to instruct payout component 224 to dispense payment to a player. Credit input component 220 and payout component 224 may communicate with credit input mechanism 221 and payout mechanism 225 via an electrical signal interface.

Metering information may be stored in hard meters 207, which may be read and modified by processor 202 via hard meter interface 206. The values in hard meters 207 are only ever incremented, and cannot be reset or decremented. The only way to alter the values stored is by running the executable code stored in game software module 231, which is executed by processor 202. The game software module 232 contains the rules of the game, the sequence of gameplay, communicates with external systems, monitors peripheral equipment, maintains integrity of the software code, etc. The processor 202 continually checks for error conditions.

According to some embodiments, processor 202 may further be in communication with a random number generator 210, to generate random numbers as required to implement one or more games of chance. Random number generator 210 may be configured to include cryptographic hashes to allow for cryptographic random number generation.

In one embodiment, gaming machine 100 may comprise a player card module 228, allowing a player to insert an identification card into a card reader (not shown) as a way of inserting and receiving credit. The player's credit amount may be stored on the card, or may be linked to data stored on the card. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming machine 100. Player card module 228 may be in communication with a monitoring system 229 to verify cards inserted into player card module 228. Monitoring system 229 may store identification card numbers along with data associated with the card such as player identification, credit totals, and/or other relevant information. According to some embodiments, data stored on monitoring system 229 may be used where a player loses or damages their card.

FIG. 3 illustrates a block diagram of a gaming system 300 according to some embodiments. The gaming system 300 may comprise a Gaming Host Machine 320, an Administration System 350, Gaming Banks 360a and 360b. Each Gaming Bank 360a, 360b comprise one of more gaming machines 100. Gaming bank 360a or 360b may be formed by a group of gaming machines that are co-located or located in close proximity of each other. In some embodiments, multiple gaming banks may be located at a single premises. Some embodiments may comprise multiple gaming banks spread across more than one premises. Some embodiments may comprise only one gaming bank 360a or 360b at a single premise or venue.

Communication between the gaming machines and the gaming host machine may be facilitated by a network 310. Network 310 may comprise interconnected switches, virtual switches, hubs, routers, cables and other networking devices configured to handle data as it passes through the network. In some embodiments, network 310 may be an Ethernet network, such as an IEEE 802.3, for example. In some embodiments, network 310 may be a wireless LAN network, such as an IEEE 802.11 network, for example.

The gaming host machine 320 comprises a memory 322 to store executable program code and a processor 321 to execute the stored program code. Processor 321 may comprise multiple processing units, chips or processing devices, but is referenced herein for simplicity as “processor 321.” Several software modules may be implemented using the stored executable program code. The gaming host machine 320 may comprise a power backup system 323 to provide power in case of a breakdown in external power supply to the gaming host machine 320. The gamine host machine 320 also comprises an intrusion detection system 328. The gaming intrusion system 328 may detect a physical unauthorised intrusion in the system by way of sensors located within the gaming machine 100. On detecting intrusion, the intrusion detection system 328 may trigger an alarm or shut down the gaming machines 100 or take another suitable safeguarding action. In some embodiments, the intrusion detection system 328 may detect a virtual intrusion into the gaming host machine 320, such as a malicious communication over the network 310, or a virus or malicious code. On detection of virtual intrusion, the intrusion detection system 328 may trigger an alarm or shut down the gaming machines 100 or take another suitable safeguarding action. Intrusion events may be logged by the gamine host machine 320 for future analysis. The code comprising program instructions to implement software modules of the gaming host machine 320 and individual gaming machines 100 may be encrypted.

The gaming host machine 320 comprises a random number generator module 324. The random number generator module 324 generates random numbers to drive games on the gaming machines 100 that are part of the gaming system 300. The game management module 325 may store gaming commands, combination tables, images, animations or art work used in games, program instructions to drive operation of games and any other necessary content, instructions or logic to operate games on the gaming machines 100 of gaming system 300. Display management module 326 may control display 340a, 340b for example. Displays 340a, 340b may be larger overhead displays located near the gaming machines in each gaming bank. Displays 340a, 340b may display content relevant to all gaming machines that are part of a gaming bank 360a or 360b, such as a jackpot value, for example. Configuration management module 327 may interface with an administration system 350 to allow an administrator to configure the various configurable parameters of the gaming host machine 320 and perform maintenance or upgrade operations on the gaming host machine 320.

The gaming host machine 320 further performs the function of establishing and maintaining one or more jackpot pools. The gaming host machine 320 may further perform the function of receiving and storing play contribution information from one or more gaming machines 100. Play contributions may comprise monetary or non-monetary contributions. The gaming host machine 320 may further perform the function of broadcasting a current jackpot value to various gaming machines 100 or displays 340a, 340b through the network 310. The gaming host machine 320 may further perform the function of receiving notifications of a jackpot win on a gaming machine 100. The gaming host machine 320 may further perform the function of resetting a jackpot to an initial state, for example a defined value. The gaming host machine 320 may further perform the function of invoking the random number generator module 324 to determine a jackpot win on a gaming machine 100. The gaming host machine 320 may further perform the function of driving display of content and animations on one or more displays 340a, 340b.

In some embodiments, the gaming host machine 320 may have an x86 architecture, executing a Linux based operating system. In some embodiments, displays 340a, 340b may be driven by an OpenGL based framework. The gaming host machine 320 may comprise one or more graphics processing units to render graphics, for example 3D graphics rendering. In some embodiments. the gaming host machine 320 may comprise 8 GB of DRAM and at least 2 MB battery backed up SRAM storage.

The gaming host machine 320 may have a configuration graphical user interface (GUI). The GUI may be accessible via network interface, for example, via a secure shell (SSH), using the administration system 350. The GUI interface could also be used to allow operator a more convenient access through the administration system 350, as the gaming host machine may be position in a location with limited physical access.

The gaming host machine 320 and the gaming machines 100 may be connected to a single Ethernet switch in embodiments with a single gaming bank. For example, for a bank of 4 machines, a 5 port Ethernet switch may be used. The gaming host machine 320 may also act as a DHCP server. Physically the gaming host machine the Ethernet Switch may be located in the base of one of the gaming machines. Further, the gaming host machine 320, may monitor one of more gaming machines 100 through communications over a serial (for example, RS232-based) connection and a monitoring protocol (for example, SAS, QCOM, ASP).

In some embodiments, especially embodiments comprising more than one gaming banks, multiple Ethernet switches may be used to avoid redundant cabling. The gaming host machine 320 may still act as a DHCP server. To deliver high quality video to the displays 340a, 340b, HDMI signal may need to be delivered over Cat6 cable using HDMI over Cat6 signal extenders, for example.

In some embodiments, the gaming host machine may control gaming machines spread over more than one location or multiple venues. Virtual Private Networks (VPN) technologies may be employed to securely extend the gaming system over more than one venue. Each venues may include a VPN router. The VPN router may establish a connection to a gaming host machine via Internet using any of applicable technologies, e.g. DSL (Digital Subscriber Line), FTTP (Fiber to the Premises), or 4G Wireless. In some embodiments, the VPN router may act as a DHCP server for a part of the network.

Secure connections may be established between the gaming host machine and rest of the components of the gaming system, including gamine machine, VPN routers, using TLS (Transport Layer Security) protocols over TCP/IP, for example. Encryption key exchange may happen during a master reset of the gaming system. At the same time, the Jackpot may be configured in the gaming host machine. Communications between the gaming host machine and rest of the components of the gaming system 300 may be encrypted end to end, irrespective of the physical location of the rest of the components of the gaming system 300.

Gaming machines 100 may be configured to present a user with one or more games of chance. During gameplay, gaming machine 100 may be configured to cause a linked jackpot feature to trigger based on a predetermined event occurring on a gaming machine 100. When the predetermined event occurs, gaming host server 320 may cause a bonus event to trigger in other gaming machines linked to gaming machine 100, as described above with reference to FIG. 3. According to some embodiments, the bonus event may itself cause a further linked jackpot feature to trigger based on a predetermined event occurring. This can cause a cascade or ricochet effect of linked gaming machines 100 participating in one or more bonus events.

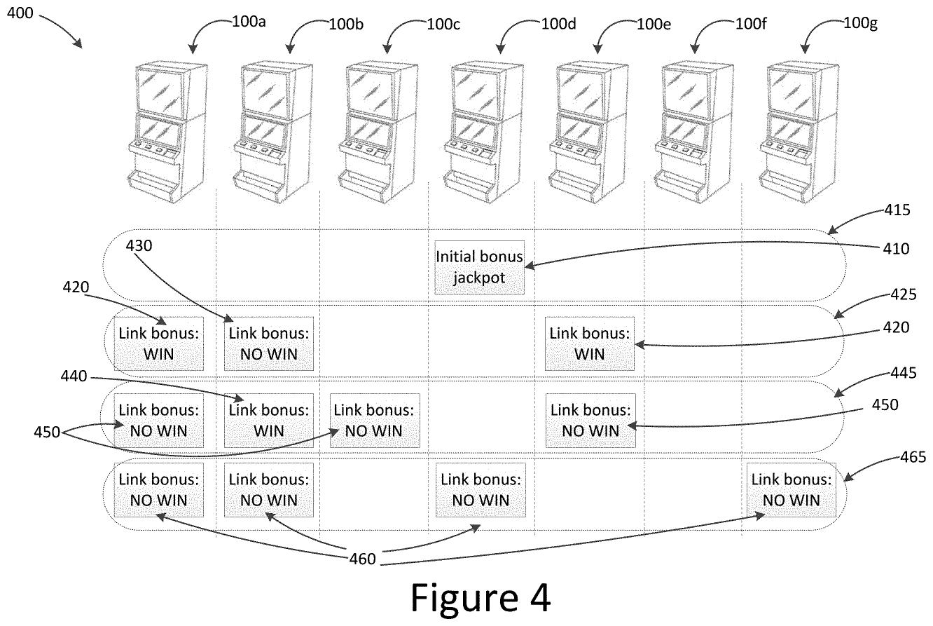

FIG. 4 shows a diagram of a linked jackpot feature in play on gaming machines 100a to 100g. At first instance, in round 415, gaming machine 100d causes an initial bonus jackpot to trigger based on the occurrence of a first predetermined event or a first winning event at 410. According to some embodiments, the first predetermined event may be the appearance of one or more predetermined symbols during play of a chance based game. According to some embodiments, the first predetermined event may be winning of a jackpot. According to some embodiments, the predetermined event may be a threshold spend amount being reached, a threshold time period having elapsed, or another event. The occurrence of the event is communicated by gaming machine 100 to gaming host machine 320. Gaming host machine 320 may be configured to subsequently cause a bonus event to occur on one or more of the other gaming machines 100 linked to gaming machine 100d via network 310.

According to some embodiments, gaming host machine 320 may be configured to only cause a bonus event to trigger only in gaming machines 100 that are determined to be eligible gaming machines 100. A gaming machine 100 may be determined to be an eligible gaming machine 100 depending on the gaming activity level on the gaming machine 100. For example, if gaming machine 100 has been sufficiently active in the time period leading up to the bonus game trigger, then it may be deemed eligible. Gaming activity level may comprise bet value or wager denominations over time on a gaming machine, frequency of betting, selection of particular play configuration or any other measure of overall activity on a gaming machine 100. For example, gaming activity level may be determined based on the amount spent on gaming machine 100, the frequency of games being played on gaming machine 100, or a duration of play on gaming machine 100, among other factors.

Once eligible gaming machines 100 have been determined, gaming host server 320 may be configured to determine which of the eligible gaming machines 100 should be caused to display the bonus event or bonus game. According to some embodiments, every identified eligible gaming machine 100 may be configured to display a bonus event. In some embodiments, only a subset of eligible gaming machines 100 may be caused to display the bonus event. According to some embodiments, a predetermined number of eligible gaming machines 100 may be selected at random from the set of identified eligible gaming machines 100, and only the predetermined number of eligible gaming machines 100 may be caused to display the bonus event.

In some embodiments, the predetermined number of eligible gaming machines 100 selected by gaming host server 320 may be determined based on the probability of any one gaming machine 100 triggering the bonus event. According to some embodiments, the number may be determined based on the following equation:

Pre-determined number×probability of bonus event<1

In other words, the number of gaming machines to be selected should be balanced against the probability of any one gaming machine 100 triggering a bonus event, so that the product of these two numbers is less than one. For example, if the probability of any one gaming machine 100 triggering a bonus event is 20%, or 0.2, then the number of selected gaming machines 100 should be less than 5.

In the illustrated embodiment in FIG. 4, the probability of any one gaming machine 100 triggering a bonus event is assumed to be 20%. After gaming machine 100d triggers the initial bonus jackpot at 410, gaming host server 320 determines the number of eligible gaming machines 100. In round 425, three gaming machines, being machines 100a, 100b, and 100e, are determined to be eligible. As the number of eligible machines is less than 5, each of gaming machines 100a, 100b and 100e are awarded a bonus event.

The bonus event or wining event may be a game of chance or other event that can further trigger consecutive bonus events in linked gaming machines 100 based on the occurrence of a second predetermined event. According to some embodiments, the second predetermined event may be the appearance of one or more predetermined symbols during play of a chance based game. According to some embodiments, the second predetermined event may be a threshold spend amount being reached, a threshold time period having elapsed, or another event. In the illustrated embodiment, the second predetermined event may be a win of the bonus game presented.

Having received a bonus event, FIG. 4 shows that gaming machines 100a and 100e win the bonus game at 420, triggering another round of bonus events. Gaming machine 100b does not win the bonus game. However, gaming machine 100b can still benefit from the next round of bonus events, being round 445. Gaming host server 320 again determines the number of eligible gaming machines 100. In the illustrated embodiment, round 445, four gaming machines 100 are identified as eligible gaming machines, being gaming machines 100a, 100b, 100c and 100e. This may be due to the fact that gaming machine 100c had an increase in activity, causing it to transition from a non-eligible machine to an eligible machine. As the number of eligible machines is less than 5, each of gaming machines 100a, 100b, 100c and 100e are awarded a bonus event.

In round 445, gaming machine 100b experiences a win in the bonus game at 440, while machines 100a, 100c and 100e do not experience a win at 450. As at least one gaming machine 100 experiences a win, a further round of bonus events is triggered, causing round 465 to occur. Gaming host server 320 again determines the number of eligible gaming machines 100. In the illustrated embodiment, in round 465, six gaming machines 100 are identified as eligible gaming machines, being gaming machines 100a, 100b, 100c, 100d, 100e and 100g. This may be due to the fact that gaming machines 100d and 100g had an increase in activity, causing them to transition from non-eligible machines to eligible machines. As the number of eligible machines is more than 5, gaming host server 320 must randomly select less than five of the gaming machines 100 to participate in round 465. Gaming machines 100a, 100b, 100d and 100g are selected and presented with the bonus game. In round 465, none of the gaming machines 100 experience a win, as shown as 460. The cascade or ricochet of bonus games therefore ends, until another gaming machine 100 triggers the bonus jackpot again by an occurrence of the first predetermined event.

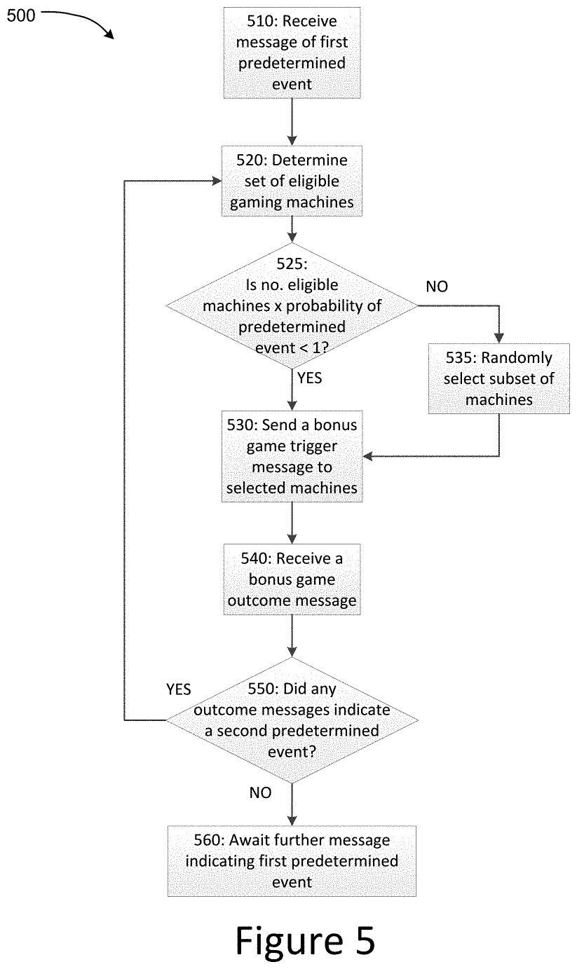

FIG. 5 shows a method 500 of facilitating a series of bonus games in a set of linked gaming machines 100 as performed by gaming host machine 320. At step 510, gaming host machine 320 receives a message from a gaming machine 100, indicating that a first predetermined event has occurred. As described above with reference to FIG. 4, the first predetermined event may be a winning event, a symbol or series of symbols being displayed, or another event. The message received at 510 indicates to gaming host server 320 that a linked bonus game event is to be triggered.

At step 520, gaming host server 320 determines a first set of eligible gaming machines 100. As described above with reference to FIG. 4, the eligible gaming machines may be determined to be active gaming machines 100 that have reached or exceeded pre-determined spend or activity thresholds in a predetermined period of time prior to the first predetermined event occurring. For example, in some embodiments, an eligible gaming machine 100 may be defined as a gaming machine 100 that has spent at least $20.00 in the hour before the first predetermined event occurs. In some embodiments, an eligible gaming machine 100 may be defined as a gaming machine 100 that has played at least 10 games in the half hour before the first predetermined event occurs.

At step 525, gaming host machine 320 determines whether the product of the number of eligible gaming machines 100 by the probability of a second predetermined event or a second winning event occurring is less than one. For example, if the probability of a second predetermined event occurring is 0.1, gaming host server 320 determines whether the set of eligible gaming machines 100 determined at step 520 is less than 10. If the number of eligible gaming machines is not less than the required amount, then at step 535 gaming host server 320 randomly selects a number of eligible gaming machines to cause the product of the number of eligible gaming machines 100 by the probability of a second predetermined event occurring to be less than 1. For example, if the probability of a second predetermined event occurring is 0.1, gaming host server 320 may select 9 gaming machines.

At step 530, gaming host server 320 sends a bonus game trigger message to the selected eligible gaming machines. According to some embodiments, receiving the trigger message may cause the selected gaming machines 100 to execute a bonus game. During the bonus game, one or more of gaming machines 100 may experience a second predetermined event or a second winning event. As described above with reference to FIG. 4, the second predetermined event may be a winning event, the display of one or more predetermined symbols, or another event. The second predetermined event may cause one or more gaming machines 100 experiencing the second predetermined event to send gaming host server 320 a bonus game outcome message.

At step 540, gaming host server 320 receives a bonus game outcome message from one or more gaming machines 100. At step 550, gaming host machine 320 determines whether or not any of the received outcome messages indicated the occurrence of a second predetermined event or a second winning event. If no second predetermined event is determined, method 500 moves to step 560, with gaming host machine 320 awaiting a further message indicating a first predetermined event, which would restart method 500 from step 510. If a second predetermined event is determined, gaming host server 320 proceeds to execute step 520, again determining an eligible set of gaming machines 100, and proceeding through method 500 again. In this way, a series of bonus games may be caused to execute, until no second triggering event is experienced by any of the gaming machines 100 playing the bonus game.

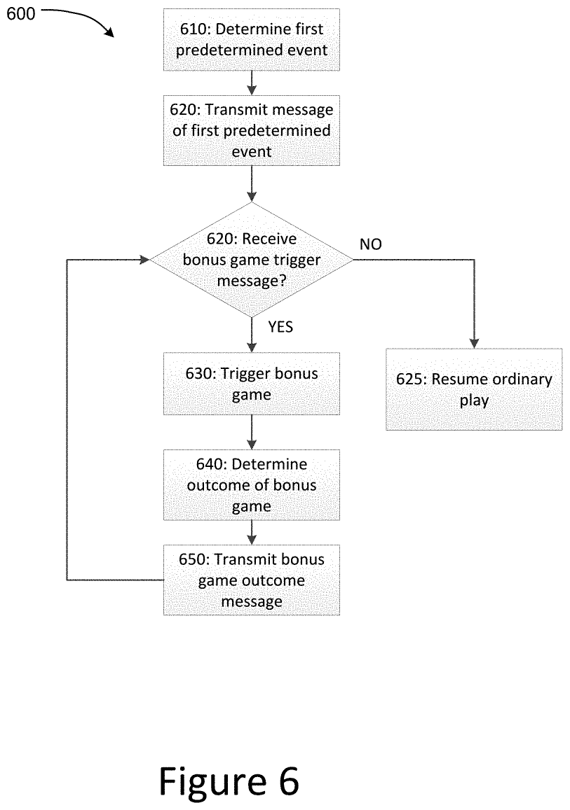

FIG. 6 shows a method 600 performed by a gaming machine 100 that is part of a linked set of gaming machines 100 involved in a linked bonus game event. At step 610, gaming machine 100 determines that a first predetermined event has occurred. As described above with reference to FIG. 4, the first predetermined event may be a winning outcome, a symbol or series of symbols being displayed, or another event.

At step 620, gaming machine 100 sends a message to gaming host server 320, indicating that a first predetermined event has occurred. The message indicates to gaming host server 320 that a linked bonus game event is to be triggered. At step 620, gaming machine 100 checks whether a bonus game trigger message has been received.

If no bonus game trigger message has been received, then at step 625 gaming machine 100 resumes ordinary play, unless a further first predetermined event or bonus game trigger message is detected.

If a bonus game trigger message is received at step 620, then a bonus game is displayed by gaming machine 100 at step 630. According to some embodiments, the bonus game may be a game of chance. According to some embodiments, the bonus game may be a reel-type game. According to some embodiments, the bonus game may be a chance based game that involves the random selection of symbols but does not display spinning reels. At step 640, the outcome of the bonus game is determined. The outcome might result in gaming machine 100 awarding a prize to the player.

At step 650, gaming machine 100 transmits a bonus game outcome message to gaming host server 320. The message may include details of the game outcome, such as whether a winning event occurred, as well as any symbols displayed. The bonus game outcome message may contain information that allows gaming host server 320 to determine whether a second predetermined event occurred, and thus whether a further round of bonus games should be triggered, as described above with reference to step 550 of method 500.

In some embodiments, a gaming machine 100 that has not experienced a first predetermined event may receive a bonus game trigger message. In that case, that gaming machine 100 may execute method 600 starting from step 620.

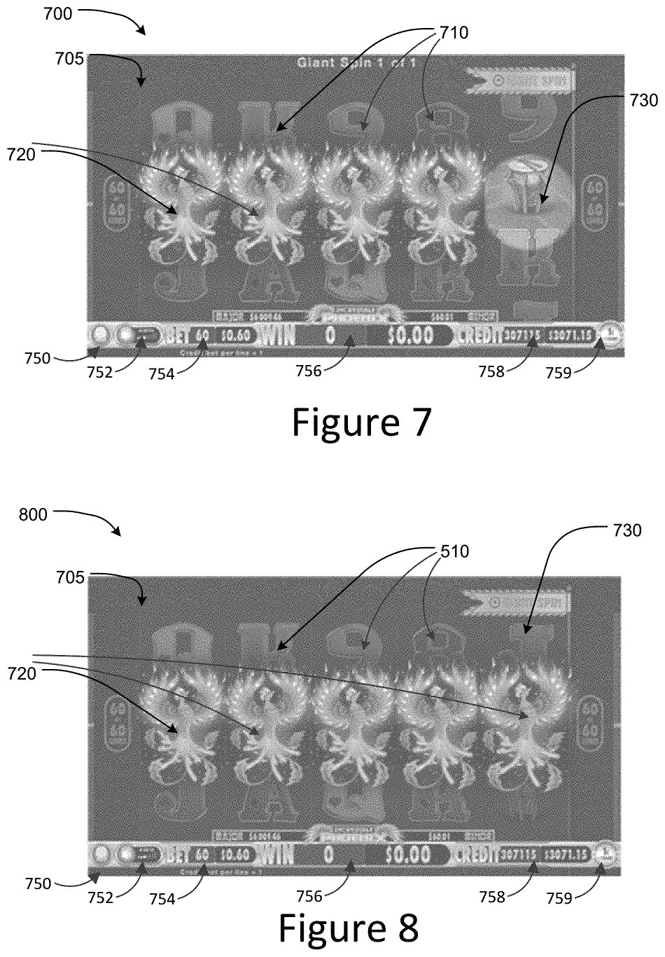

FIG. 7 shows an example screenshot 700 during a trigger sequence. Screenshot 700 shows a game play are 705 having a number of spinning reels 710. The combination of symbols displayed shows four phoenixes 720 displayed, with the last reel 730 yet to land on a symbol. According to the illustrated embodiment, five phoenixes appearing may correspond to the first predetermined event or the first winning event as described above with reference to FIGS. 4, 5 and 6.

Screenshots 700 also show a progress bar 750, displaying current game information to a user. For example, volume display 752 displays a currently selected volume level for the game. Bet indicator 754 show the number of credits and the corresponding currency amount selected as the bet amount for the current game. In the illustrated embodiment, the bet amount is shown as 60 credits, or 60 cents. Win meter 756 shows a total amount of credits and currency won by the user in the current game. In the illustrated embodiments, the win meter shows that no credits or currency has been won. Credit meter 758 shows the number of credits and corresponding currency that the player has available to play with. In the illustrated embodiment, the player has 307115 credits, or $3071.15 in credit. Credit exchange converter 759 shows the credit to currency conversion for the present game. In the illustrated example, 1 credit is shown as being equivalent to 1 cent.

FIG. 8 shows an example screenshot 800 during a jackpot event. As compared to FIG. 7, FIG. 8 shows that the last reel 730 has now finished rotating and has displayed a phoenix 720. As five phoenixes are now displayed, this may cause gaming machine 100 to communicate with gaming host server 320, to indicate that a first predetermined event has occurred, as described above with reference to FIGS. 4, 5 and 6.

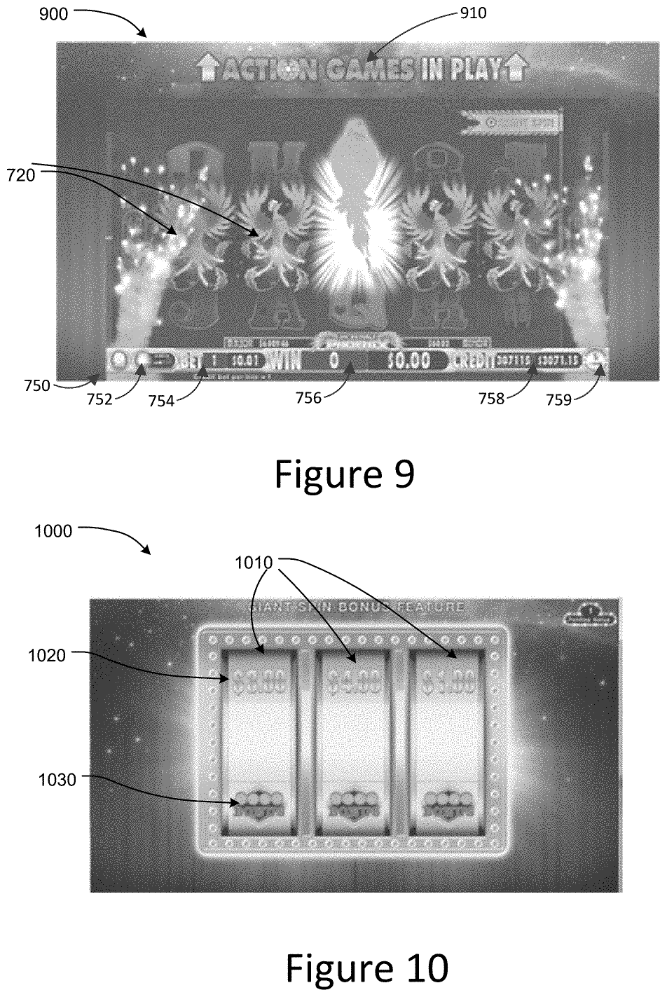

FIG. 9 shows an example screenshot 900 during a jackpot event. A celebratory animation is displayed, and a bonus game indicator 910 is shown. Bonus game indicator 910 may direct the player's attention to a second screen of gaming machine 100 where a bonus gem is to be displayed. For example, where screenshot 900 is displayed on screen 108 of gaming machine 100, bonus game indicator 910 may direct the player's attention to secondary screen 120.

FIG. 10 shows an example screenshot 1000 which may be displayed on secondary screen 120 of gaming machine 100. Screenshot 1000 displays reels 1010 configured to spin and display randomly selected symbols to a user. Symbols may include credit symbols 1020, displaying an amount of credit that may be won by a user. Symbols may also include bonus symbols 1030. According to some embodiments, the appearance of bonus symbols 1030 may be the second predetermined event, causing the triggering of a further round of bonus games, as described above with reference to FIGS. 4 to 6.

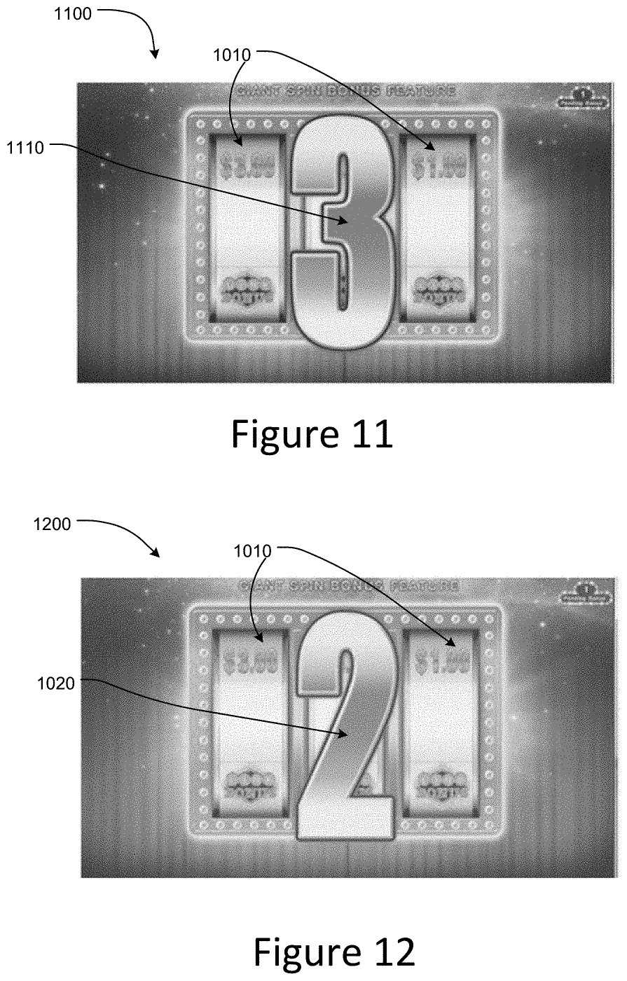

FIG. 11 shows an example screenshot 1100 which may be displayed on secondary screen 120 of gaming machine 100. Screenshot 1100 displays reels 1010 configured to spin and display randomly selected symbols to a user. Screenshot 1100 also displays an overlay countdown symbol 1110. Countdown symbols may be displayed for a predetermined time before a bonus game is initiated to cause a sense of anticipation in the player.

FIG. 12 shows an example screenshot 1200 which may be displayed on secondary screen 120 of gaming machine 100. Screenshot 1200 displays reels 1010 configured to spin and display randomly selected symbols to a user. Screenshot 1100 also displays an overlay countdown symbol 1210. Countdown symbols 1210 is decremented compared to countdown symbol 1110.

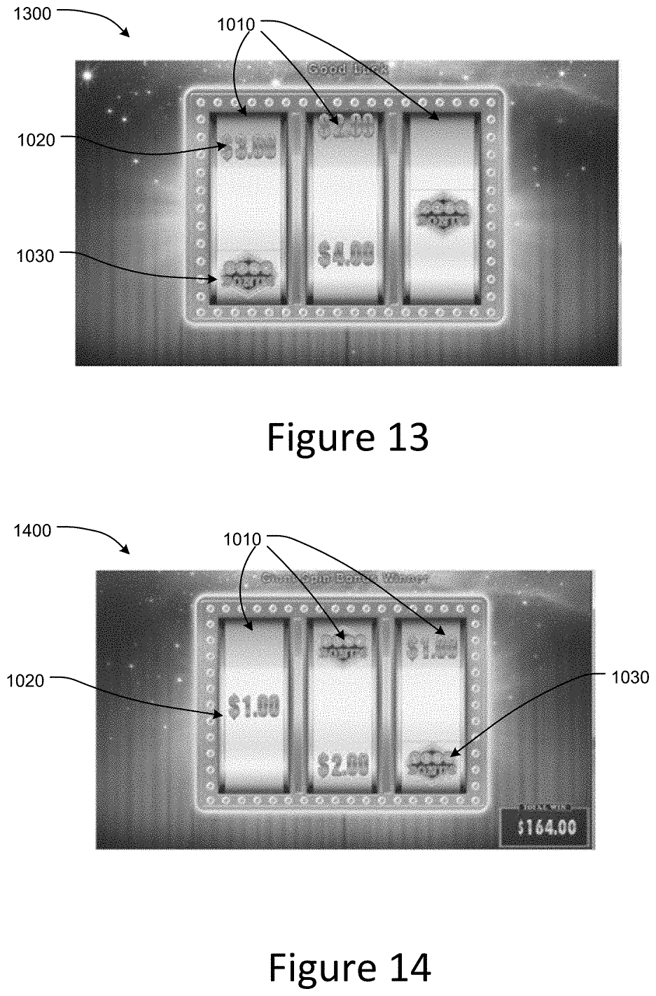

FIG. 13 shows an example screenshot 1300 which may be displayed on secondary screen 120 of gaming machine 100. Screenshot 1300 displays spinning reels 1010 during a spin.

FIG. 14 shows an example screenshot 1400 which may be displayed on secondary screen 120 of gaming machine 100. Screenshot 1400 displays spinning reels 1010 at the end of a spin. The display of credit symbols 1020 may result in a prize awarded to the player, being the total of the credit displayed. For example, in the illustrated embodiments, $4.00 may be awarded to the player. Although two bonus symbols 1030 are shown, as described above, in the illustrated embodiments 3 bonus symbols 1030 in a row must be displayed to trigger a further bonus game. In some alternative embodiments, a different number or configuration of bonus symbols 1030 may be sufficient to cause a further bonus game to be triggered.

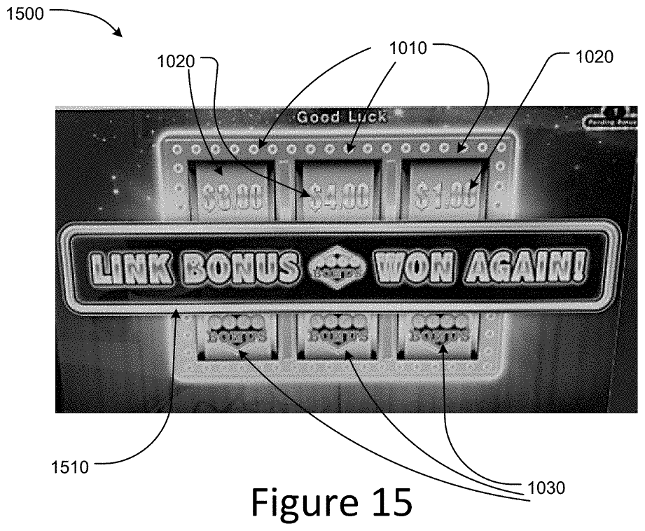

FIG. 15 shows an example screenshot 1500 which may be displayed on secondary screen 120 of gaming machine 100. Screenshot 1500 displays spinning reels 1010 at the end of a spin different from screenshot 1400. The spinning reels 1010 of screenshot 1500 show symbols 1020 and 1030 aligned across the spinning reels 1010 resulting in occurrence of a predetermined event or a winning event on the gaming machine 100. A message 1510 is displayed based on the occurrence of the winning event to indicate to the player that the same player or machine has been awarded a prize again based on the occurrence of a repeated or further predetermined event or winning event as described above with reference to FIGS. 4 to 6.

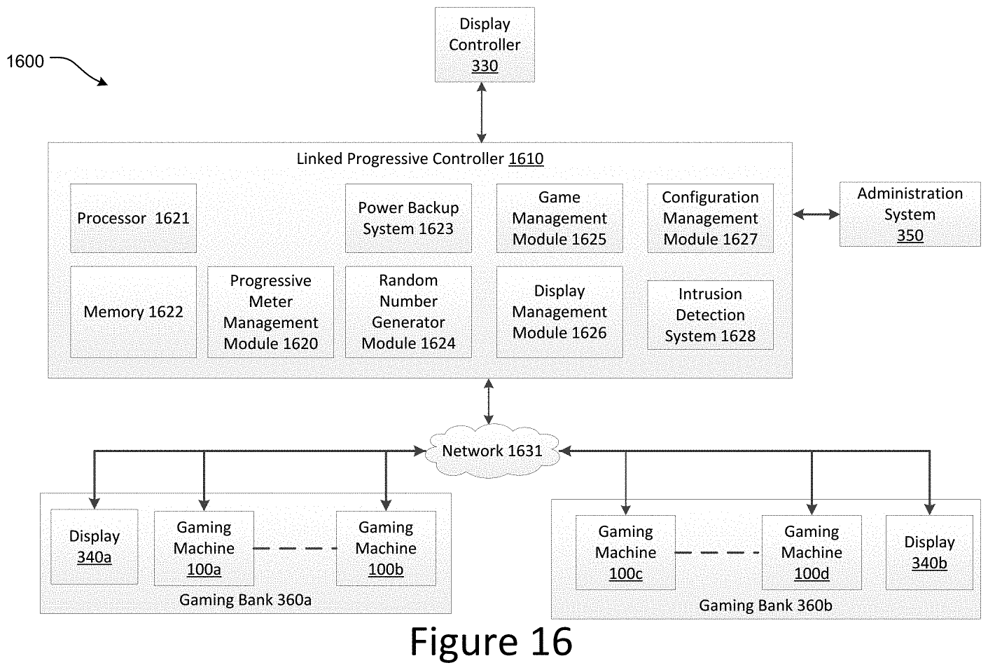

FIG. 16 illustrates a block diagram of a gaming system 1600 according to some embodiments. The gaming system 1600 is similar to the gaming system 300 of FIG. 3, with the difference being that the gaming system 1600 does not comprise a dedicated gaming host machine 320. Instead of the gaming host machine 320, the gaming system 1600 relies on the linked progressive controller 1610 to facilitate communication to allow for shared award generation among the linked pool of gaming machines 100. Several gaming venues have a linked progressive controller 1610 to facilitate progressive prizes for a group of gaming machines. A linked progressive controller 1610 can be relied on to facilitate the shared award generation among the linked pool of gaming machines 100 while avoiding the need of a dedicated gaming host machine 320 specifically for shared award generation among the linked pool of gaming machines 100.

The linked progressive controller 1610 comprises a memory 1622 to store executable program code and a processor 1621 to execute the stored program code. Processor 1621 may comprise multiple processing units, chips or processing devices, but is referenced herein for simplicity as “processor 1621.” Several software modules may be implemented using the stored executable program code. The linked progressive controller 1610 may comprise a power backup system 1623 to provide power in case of a breakdown in external power supply to the linked progressive controller 1610. The linked progressive controller 1610 also comprises an intrusion detection system 1628. The intrusion detection system 1628 may detect a physical unauthorised intrusion in the system by way of sensors located within the gaming machine 100. On detecting intrusion, the intrusion detection system 1628 may trigger an alarm or shut down the gaming machines 100 or take another suitable safeguarding action. In some embodiments, the intrusion detection system 1628 may detect a virtual intrusion into the linked progressive controller 1610, such as a malicious communication over a network 1631, or a virus or malicious code. On detection of virtual intrusion, the intrusion detection system 1628 may trigger an alarm or shut down the gaming machines 100 or take another suitable safeguarding action. Intrusion events may be logged by the linked progressive controller 1610 for future analysis. The code comprising program instructions to implement software modules of the linked progressive controller 1610 may be encrypted.

The linked progressive controller 1610 also comprises a progressive meter management module 1620. The progressive meter management module 1620 manages a progressive meter value. The progressive meter value keeps track of the amount associated with a progressive jackpot. The linked progressive controller 1610 sends regular updates regarding the progressive meter value to the gaming machine 100 in the form of progressive meter value messages. In the event that a progressive win event occurs, the gaming machine 100 receives an update from the linked progressive controller 1610 indicating a decrement or reset of the progressive meter value.

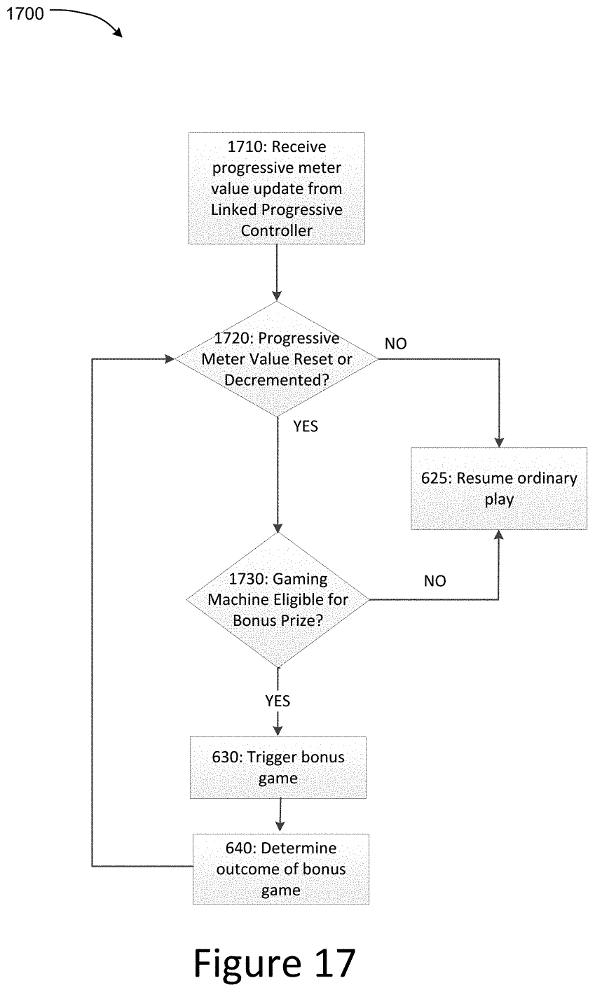

FIG. 17 is a flowchart of a method 1700 including steps for execution of a linked bonus game on the gaming machine 100 of FIG. 1 that is part of the gaming system 1600 of FIG. 16. Some steps of the flowchart 1700 are identical or similar to the steps of the flowchart 600 of FIG. 6.

At step 1710, the gaming machine 100 receives an update from the linked progressive controller 1610 regarding an update in the progressive meter value. At step 1720, the gaming machine 100 determines whether the progressive meter value has been reset or decremented. The resetting or decrementing of the progressive meter value may occur as a response to an award of a linked progressive jackpot on a gaming machine 100 that is part of the gaming system 1600.

If the progressive meter value has not been reset or decremented, then the gaming machine 100 resumes or continues ordinary operations at step 625. If the progressive meter value has been reset or decremented, the gaming machine 100 performs step 1730, at which it determines whether the gaming machine 100 is eligible for initiation of a bonus prize game. The eligibility is determined based on several factors comprising: value of a credit meter obtained through the credit input component 220, a turnover rate for gaming activity on the gaming machine 100, an accumulated bonus prize pool for the gaming machine.

If at step 1730, it is determined that the gaming machine 100 is not eligible for the bonus prize, then the gaming machine 100 resumes ordinary play at step 625. If at step 1730, it is determined that the gaming machine 100 is eligible for initiation of a bonus prize game, then at step 630 a bonus game is initiated by a bonus game module that is part of the game software module 231 of the gaming machine 100. In some embodiments, the bonus game may be initiated on a second screen of the gaming machine 100. The bonus game may comprise a reel spinning feature game.

At step 640 a determining of the outcome of the bonus game occurs based on the conditions of chance associated with the bonus game. The outcome might result in gaming machine 100 awarding a prize to the player. In the gaming system 1600, there is no need for a gaming machine to communicate the occurrence of a bonus prize award to other gaming machines or a gaming host machine because the linked progressive controller 1610 centrally initiates the awarding of the bonus prize based on the common progressive meter value accessible to all gaming machines.

In some embodiments, the outcome of the bonus game may include a variable reoccurring consolation bonus prize. The variable reoccurring consolation bonus prize may initiate or trigger a further bonus game on any one of the gaming machines 100 part of the gaming system 1600.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A gaming host machine configured to communicate with a pool of gaming machines, the gaming host machine comprising:
a processor;
memory storing executable program code;
wherein the processor is configured to execute the program code to:
receive a message from a first gaming machine, the first gaming machine being part of the pool of gaming machines, the message indicating occurrence of a first winning event on the first gaming machine;
determine a first set of eligible gaming machines from the pool of gaming machines;
send a first bonus game trigger message to each of the first set of eligible gaming machines, the first bonus game trigger message comprising instructions to trigger a first bonus game on each of the first set of eligible gaming machines;
receive a first bonus game outcome message from each of the eligible gaming machines.

2. The gaming host machine of claim 1, wherein the processor is further configured to determine occurrence of a second winning event on a second gaming machine based on the received first bonus game outcome messages, the second gaming machine being one of the first set of eligible gaming machines.

3. The gaming host machine of claim 2, wherein in response to determining occurrence of the second winning event, the processor is further configured to:
determine a second set of eligible gaming machines from the pool of gaming machines;
send a second bonus game trigger message to each of the second set of eligible gaming machines, the second bonus game trigger message comprising instructions to trigger a second bonus game on each of the second set of eligible gaming machines;
receive a second bonus game outcome message from each of the second set of eligible gaming machines.

4. The gaming host machine of claim 3, wherein the processor is further configured to determine occurrence of a third winning event on a third gaming machine based on one or more of the received second bonus game outcome messages.

5. The gaming host machine of claim 1, wherein the processor is further configured to receive activity level messages from each gaming machine part of the pool of gaming machines, the activity level messages indicating gaming activity level on each gaming machine.

6. The gaming host machine of claim 5, wherein the determination of the first set of eligible gaming machines is based on the gaming activity level on each of the pool of gaming machines.

7. A gaming system comprising the gaming host machine of claim 1 and at least one gaming machine, the gaming machine comprising:
a gaming machine processor;
gaming machine memory storing executable program code;
at least one display to display game-related images; and
input components to receive player input;
wherein the processor is configured to execute the program code to:
transmit a message to the gaming host machine, the message indicating occurrence of a first winning event on the gaming machine;
receive a first bonus game trigger message from the gaming host machine, the first bonus game trigger message comprising instructions to trigger a first bonus game;
trigger the first bonus game,
determine an outcome of the first bonus game;
transmit a first bonus game outcome message to the gaming host machine;
wherein the at least one gaming machine is part of the pool of gaming machines.

8. The gaming system of claim 7, wherein the gaming machine processor is further configured to execute the program code to:
receive a second bonus game trigger message, the second bonus game trigger message comprising instructions to trigger a second bonus game;
trigger a second bonus game,
determine an outcome of the second bonus game;
transmit a second bonus game outcome message to the gaming host machine.

9. The gaming system of claim 7, wherein the gaming machine processor is further configured to execute the program code to transmit activity level messages to the gaming host system, the activity level messages indicating gaming activity level on the at least one gaming machine.

10. The gaming system of claim 9, wherein the gaming machine processor is further configured to determine activity level based on wager denominations on the at least one gaming machine over a period of time.

11. A method of gaming comprising the steps of:
receiving, by a gaming host machine a message from a first gaming machine, the first gaming machine being part of the pool of gaming machines, the message indicating occurrence of a first winning event on the first gaming machine;
determining, by the gaming host machine a first set of eligible gaming machines from the pool of gaming machines;
sending, by the gaming host machine a first bonus game trigger message to each of the first set of eligible gaming machines, the first bonus game trigger message comprising instructions to trigger a first bonus game on each of the first set of eligible gaming machines;
receiving, by the gaming host machine, a first bonus game outcome message from each of the eligible gaming machines.

12. The method of claim 11 further comprising the step of determining, by the gaming host machine, occurrence of a second winning event on a second gaming machine based on the received first bonus game outcome messages, the second gaming machine being one of the first set of eligible gaming machines.

13. The method of claim 12, further comprising, in response to determining occurrence of the second winning event, the steps of:
determining, by the gaming host machine, a second set of eligible gaming machines from the pool of gaming machines;
sending, by the gaming host machine, a second bonus game trigger message to each of the second set of eligible gaming machines, the second bonus game trigger message comprising instructions to trigger a second bonus game on each of the second set of eligible gaming machines;
receiving, by the gaming host machine, a second bonus game outcome message from each of the second set of eligible gaming machines.

14. The method of claim 13, further comprising, determining, by the gaming host machine, occurrence of a third winning event on a third gaming machine based on one or more of the received second bonus game outcome messages.

15. The method of claim 11, further comprising the step of, receiving, by the gaming host machine, activity level messages from each gaming machine part of the pool of gaming machines, the activity level messages indicating gaming activity level on each gaming machine.

16. The method of claim 15, wherein the determination of the first set of eligible gaming machines is based on the gaming activity level on each of the pool of gaming machines.

17. The method of claim 11, further comprising the steps of:
transmitting, by at least one gaming machine a message to the gaming host machine, the message indicating occurrence of a first winning event on the gaming machine;
receiving, by the gaming machine, a first bonus game trigger message from the gaming host machine, the first bonus game trigger message comprising instructions to trigger a first bonus game;
triggering, on the gaming machine, the first bonus game,
determining, by the gaming machine, an outcome of the first bonus game;
transmitting, by the gaming machine, a first bonus game outcome message to the gaming host machine;
wherein the at least one gaming machine is part of the pool of gaming machines.

18. The method of claim 11, further comprising the steps of:
receiving, by the at least one gaming machine, a second bonus game trigger message, the second bonus game trigger message comprising instructions to trigger a second bonus game;
triggering, on the at least one gaming machine, a second bonus game, determining, by the at least one gaming machine, an outcome of the second bonus game;
transmitting, by the at least one gaming machine, a second bonus game outcome message to the gaming host machine.

19. The method of claim 17, further comprising the step of transmitting, by the at least one gaming machine, activity level messages to the gaming host system, the activity level messages indicating gaming activity level on the at least one gaming machine.

20. The method of claim of claim 19, wherein the activity level is based on wager denominations on the at least one gaming machine over a period of time.

21. A gaming machine configured to communicate with a linked progressive controller machine, the gaming machine comprising:
at least one gaming machine processor;
gaming machine memory storing executable program code;
at least one display to display game-related images; and
input components to receive player input;
wherein the at least one gaming machine processor is configured to execute the program code to:
receive a progressive meter value message from the linked progressive controller machine, the progressive meter value message indicating a change in the progressive meter value;
on determining a decrement or reset of a progressive meter value based on the progressive meter value message, trigger a first bonus game;
determine an outcome of the first bonus game;
wherein the at least one gaming machine is part of a pool of gaming machines and the linked progressive controller machine transmits the progressive meter value message to at least another gaming machine part of the pool of gaming machines.
